(19) United States
(12) Patent Application Publication
(10) Pub. No.: US 2008/0105793 A1
(43) Pub. Date: May 8, 2008

(54) Apparatus to protect cable and/or electrical wires penetrating a roof of a building

(76) Inventor: Henry Barnes, West Haven, CT (US)

Correspondence Address: JAMES RAY & ASSOCIATES, 2640 PITCAIRN ROAD, MONROEVILLE, PA, 15146, US

(21) Appl. No.: 11/592,774

(22) Filed: Nov. 3, 2006

(51) Int. Cl. F16L 5/02

(52) U.S. Cl. 248/56

(57) ABSTRACT

Apparatus for protecting television cables and/or electrical wires penetrating a roof of a building includes an elongated hollow member having a predetermined cross-sectional shape and length. A hollow U-shaped member is attached at one end thereof to an end of such elongated hollow member. A second end of the hollow U-shaped member faces downwardly toward such roof when installed for preventing rain and/or snow from entering an interior portion of the elongated hollow member and the hollow U-shaped member. Such hollow U-shaped member having each of a second predetermined cross-sectional shape and a predetermined radius. A seal is disposed in such hollow U-shaped member adjacent the first end after such television cables and/or electrical wires have been placed therein. There is an attachment mechanism engageable with each of an exterior surface of the elongated hollow member and a predetermined structural member of such building for securing such apparatus to such roof structure.

### FIELD OF THE INVENTION

The present invention relates, in general, to electrical cables and/or television transmission lines installed in a building and, more particularly, this invention relates to an apparatus to protect these electrical cables and/or transmission lines for satellite television transmission lines.

### BACKGROUND OF THE INVENTION

Prior to the conception and development of the instant invention, it has been desirable to be able to pass wires through the roof of a structure to avoid unsightly wires being connected to the exterior of such structure. However, difficulties have been encounter in prior art techniques utilized for passing electrical wires through the roof of a building either residential or commercial.

Typically, this has been accomplished using boxes mounted to the roof and having electrical conduit connected thereto for passing wiring therethrough. Thereafter the box is filled with a hot pitch to seal the conduit.

This scheme for passing wiring through the roof has not been entirely satisfactory. On a hot day, for example the pitch may soften and seep through the space between the conduit and the box. Over time, the pitch level in the box will diminish and rain and/or snow will be able top collect in the box thereby greatly enhancing the chances of the pitch cracking and allowing water to penetrate the roof structure.

A roof-top mounted wiring assembly has been taught in U.S. Pat. No. 6,795,300 which was one attempt to solve to solve this problem. This wiring assembly is mounted to a roof curb of a structural roof and includes an elongated housing member which extends axially between a first end and a second end thereof. There is a flashing skirt disposed at an axially intermediate position of the elongated housing member for sealingly engaging the roof curb.

### SUMMARY OF THE INVENTION

The present invention provides an apparatus for protecting at least one of television cables and electrical wires penetrating a roof structure of a building. This apparatus includes an elongated generally hollow member having each of a first predetermined cross-sectional shape and a predetermined length. Additionally, such elongated generally hollow member is preferably substantially straight and is formed from a first predetermined material. There is a generally hollow U-shaped member attached at a first end thereof to a first end of the elongated generally hollow member. A second end of such generally hollow U-shaped member faces downwardly toward such roof when installed for preventing one of rain and snow from entering an interior portion of each of such elongated generally hollow member and such generally hollow U-shaped member. The generally hollow U-shaped member includes each of a second predetermined cross-sectional shape and a predetermined radius. The generally hollow U-shaped member is formed from a second predetermined material. A sealing means is disposed in the first end of such generally hollow U-shaped member after such at least one of such television cables and electrical wires have been place therein. Finally, there is an attachment means engageable with an exterior surface of the elongated generally hollow member at a predetermined location thereon and a predetermined structural member of such building for securing the apparatus to the roof.

### OBJECTS OF THE INVENTION

It is, therefore, one of the primary objects of the present invention to provide an apparatus for protecting at least one of television cables and electrical wires penetrating a roof structure of a building from damage.

Another object of the present invention is to provide an apparatus for protecting at least one of television cables and electrical wires penetrating a roof structure of a building which is easy to install.

Still another object of the present invention is to provide an apparatus for protecting at least one of television cables and electrical wires penetrating a roof structure of a building which is relatively inexpensive to manufacture.

Yet another object of the present invention is to provide an apparatus for protecting at least one of television cables and electrical wires penetrating a roof structure of a building which is lightweight.

An additional object of the present invention is to provide an apparatus for protecting at least one of television cables and electrical wires penetrating a roof structure of a building which will enhance the exterior appearance of a building by eliminating unsightly cables attached thereto.

A further object of the present invention is to provide an apparatus for protecting at least one of television cables and electrical wires penetrating a roof structure of a building which will minimize damage to such at least one of television cables and electrical wires.

Still yet another object of the present invention is to provide an apparatus for protecting at least one of television cables and electrical wires penetrating a roof structure of a building which allows easier additional wires to be added at a later date.

In addition to the several objects and advantages of the present invention which have been described with some degree of specificity above, it should be noted that various additional objects and advantages of the present invention will become more readily apparent to those persons skilled in the relevant art from the following more detailed description of the invention, particularly, when such description is taken in conjunction with the attached drawing Figures and with the appended claims.

### BRIEF DESCRIPTION OF THE DRAWINGS

FIG. 1 is a side elevation view of the apparatus manufactured according to a presently preferred embodiment of the invention installed in a roof structure and having an electrical wire pulled therethrough; and

FIG. 2 is a side elevation view of the apparatus manufactured according to a presently preferred embodiment of the invention installed in a roof structure and having a television cable drawn therethrough.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding of the invention, identical components having identical functions have been identified with identical reference numerals throughout the several views illustrated in the drawing figures.

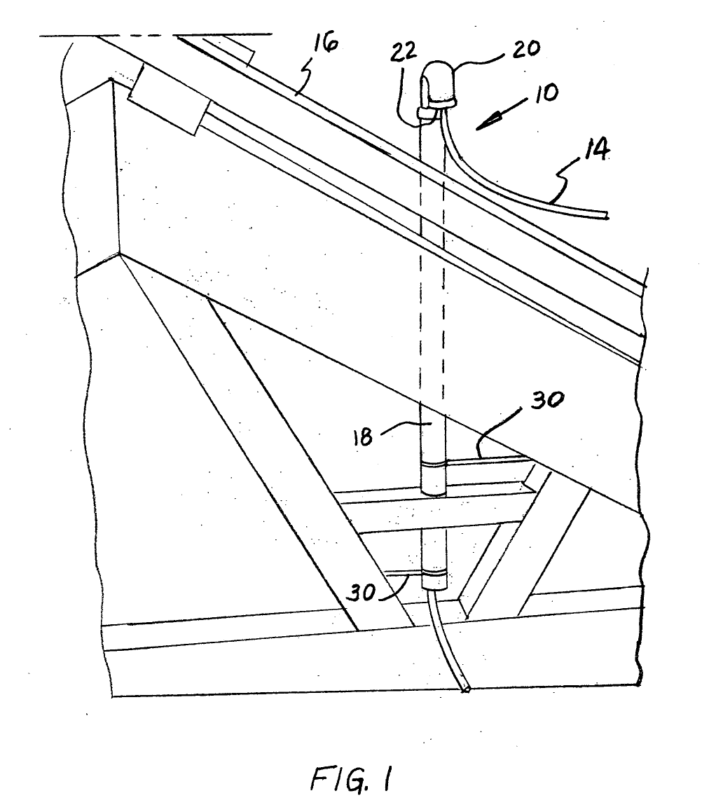

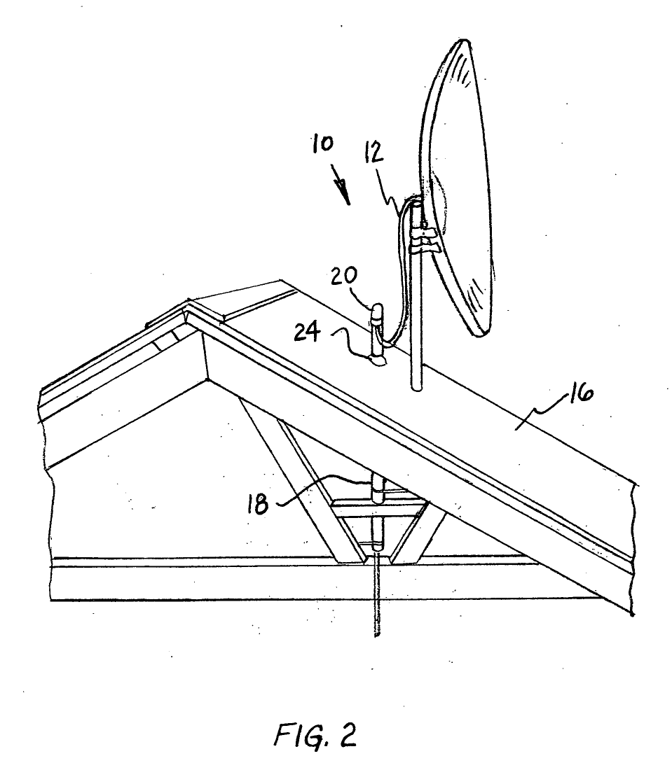

Now reference is made, more particularly, to FIGS. 1 and 2 of the drawings. Illustrated therein is a presently preferred embodiment of the apparatus, generally designated 10, for protecting at least one of television cables 12 and electrical wires 14 penetrating a roof structure 16 of a building (not shown).

The apparatus 10 includes an elongated generally hollow member 18 having each of a first predetermined cross-sectional shape and a predetermined length. Such elongated generally hollow member 18 being substantially straight and formed from a first predetermined material. Such first predetermined shape may consist of any well known geometric shape such as generally round, oval, rectangular, hexagonal and octagonal. Preferably, such first predetermined cross sectional shape is generally round. Such first predetermined material is selected from the group consisting of plastic, preferably PVC and metal, preferably aluminum. In the most preferred embodiment such first predetermined material is PVC.

Apparatus 10 also has a generally hollow U-shaped member 20 attached at a first end thereof to a first end of said elongated generally hollow member 18. A second end of such generally hollow U-shaped member 20 faces downwardly toward such roof 16 when installed for preventing one of rain and snow from entering an interior portion (not shown) of each of the elongated generally hollow member 18 and such generally hollow U-shaped member 20. Such generally hollow U-shaped member 20 having a second predetermined cross-sectional shape. Such second predetermined cross-sectional shape is selected from one of generally round, oval, rectangular, hexagonal and octagonal and in the presently preferred embodiment such second predetermined cross sectional shape is generally round.

Such generally hollow U-shaped member 20 is formed from a second predetermined material selected from the group consisting of plastic and metal. Preferably, the second predetermined material is plastic. Most preferably, such plastic is PVC.

Apparatus 10 further includes a sealing means 22, such as silicon, disposed in such generally hollow U-shaped member 20 adjacent the first end thereof after such at least one of such television cables 12 and electrical wires 14 have been placed therein. Additionally, in the presently preferred embodiment of the invention such apparatus 10 further includes a means 24, preferably silicon, disposed around and in sealing contact with such elongated generally hollow member 18 and with such roof 16 for sealing an opening in such roof 16 where such apparatus 10 enters therein.

There is an attachment means, generally designated 30, engageable with each of an exterior surface of such elongated generally hollow member 18 at a predetermined location thereon and a predetermined structural member of such building for securing the apparatus 10 to such roof structure.

While both a presently preferred and various alternative embodiments of the present invention have been described in detail above, it should be noted that various other modifications and adaptations of the invention may be made by those persons skilled in the art without departing from either the spirit of the invention or the scope of the appended claims.

I claim:

1. An apparatus for protecting at least one of television cables and electrical wires penetrating a roof structure of a building, said apparatus comprising:
(a) an elongated generally hollow member having each of a first predetermined cross-sectional shape and a predetermined length, said elongated generally hollow member being substantially straight and formed from a first predetermined material;
(b) a generally hollow U-shaped member attached at a first end thereof to a first end of said elongated generally hollow member, a second end of said generally hollow U-shaped member facing downwardly toward such roof when installed for preventing one of rain and snow from entering an interior portion of each of said elongated generally hollow member and said generally hollow U-shaped member, said generally hollow U-shaped member having a second predetermined cross-sectional shape, said generally hollow U-shaped member being formed from a second predetermined material;
(c) a sealing means disposed in said generally hollow U-shaped member adjacent said first end thereof after such at least one of such television cables and electrical wires have been placed therein; and
(d) an attachment means engageable with each of an exterior surface of said elongated generally hollow member at a predetermined location thereon and a predetermined structural member of such building for securing said apparatus to such roof structure.

2. An apparatus, according to claim 1, wherein said first predetermined cross-sectional shape is one of generally round, oval, rectangular, hexagonal and octagonal.

3. An apparatus, according to claim 1, wherein said first predetermined cross sectional shape is generally round.

4. An apparatus, according to claim 1, wherein said first predetermined material is selected from the group consisting of plastic and metal.

5. An apparatus, according to claim 3, wherein said first predetermined material is plastic.

6. An apparatus, according to claim 5, wherein said plastic is PVC.

7. An apparatus, according to claim 1, wherein said second predetermined cross-sectional shape is one of generally round, oval, rectangular, hexagonal and octagonal.

8. An apparatus, according to claim 1, wherein said second predetermined cross sectional shape is generally round.

9. An apparatus, according to claim 1, wherein said second predetermined material is selected from the group consisting of plastic and metal.

10. An apparatus, according to claim 9, wherein said second predetermined material is plastic.

11. An apparatus, according to claim 10, wherein said plastic is PVC.

12. An apparatus, according to claim 1, wherein said sealing means is silicon.

13. An apparatus, according to claim 1, wherein said apparatus further includes a means disposed around and in sealing contact with said elongated generally hollow member and with such roof for sealing an opening in such roof where said apparatus enters therein.

14. An apparatus, according to claim 13, wherein said means disposed around and in sealing contact with said elongated generally hollow member and with such roof for sealing an opening in such roof is silicon.
